(19) United States
(12) Patent Application Publication
(10) Pub. No.: US 2003/0233765 A1
(43) Pub. Date: Dec. 25, 2003

(54) Centrifugal dryer and method

(76) Inventors: Alan Heinzen, Gilroy, CA (US); Erick A. Davidson, Salinas, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/427,588

(22) Filed: Apr. 30, 2003

Related U.S. Application Data
(60) Provisional application No. 60/377,265, filed on Apr. 30, 2002.

(51) Int. Cl. F26B 17/24; F26B 17/30

(52) U.S. Cl. 34/321; 34/58

(57) ABSTRACT

The present invention is a dryer for use with solid-form objects suitable for a continuous process production environment, such as some kinds of produce and vegetables. The apparatus uses a variable-speed accelerator belt to rapidly load objects. The dryer has a domed shaped retaining door to force objects to the perimeter of the perforated spinning drum. In operation the apparatus uses a method to vary the speed of the accelerator belt to accomplish even self-balanced stacking of the objects within the drum. The method also includes varying the drum rotation speed from a slow rotation during loading, permitting self-balancing of the contents of the drum, to a higher drying speed that extracts liquid from the objects.

### FIELD OF THE INVENTION

The present invention pertains to a centrifugal dryer including a rotatably mounted drum. More specifically, the apparatus is a centrifugal dryer for use in removing surface liquids from vegetables or other solid-form objects.

### BACKGROUND OF THE INVENTION

In the field of vegetable processing, centrifugal dryers have been used after the cleaning process to remove surface liquids prior to packaging. Examples of such useful inventions include perforated drums that rotate the vegetables around the longitudinal axis of the drum. Generally, the washed vegetables are loaded into a stopped drum. Then the drum is spun in order to remove surface liquids. Some prior art drums are canted at an angle in order to facilitate loading and unloading.

Many pre-existing dryers use doors to hold the vegetables in the drum during loading and drying. Machines without doors to contain the vegetables have been described and these machines generally use centripetal force to press the vegetables against the walls of the spinning cylinder, which prevents the vegetables from leaving the drum until the rate of rotation of the drum is slowed, reducing the centripetal forces experienced by the vegetables. For example, a pre-existing machine has been described in U.S. Pat. No. 5,581,904. This machine insertions vegetables into the cylinder and they are forced to the far end of the drum because the cylinder is canted. Subsequent placement of vegetables is forced to the far end until arrested by vegetables already present in the cylinder. Most pre-existing drums are supported by centrally located spindle with radially extending arms extending between the spindle and the inner surface of the drum that supports the weight of both the cylinder and the vegetables.

There are a number of common problems with the pre-existing dryer designs. For example the radial arms can interfere with even loading. Some of the dryers are designed so that the drum does not come to a complete stop when loading. In such designs, the radial arms may contact and damage the vegetables being loaded. In many cases, the drum may become unbalanced due to improper stacking of the produce.

What is needed is a dryer and method that addresses some these and other disadvantages and deficiencies of the prior art.

### SUMMARY OF THE INVENTION

The present invention is a drying apparatus for use with many kinds of objects, but is particularly suited for use in drying washed most kinds of produce and vegetables including but not limited to leaf vegetables. The apparatus includes a means for rapidly loading objects into a centrifugal drying mechanism, a preferably domed shaped retaining door to control unloading, and a separate means for removing the objects at the completion of the drying cycle. The drum is preferably perforated and tapered along the entire length of the drying section of the drum. Further, the drum is supported by several load-bearing trunion wheels in contact with the exterior of said drum. The trunion wheels may be placed at many potential locations on said drum, and one skilled in the art can easily select the number and placement of such wheels appropriate for any given dryer configuration

Associated with the apparatus is a method to vary the speed of the loading mechanism thereby allowing a controlled stacking and distribution of the objects within the drum. The method also includes the step of varying the drum rotation speed from a slow rotation during loading (which reduces damage to the objects and may permit self-balancing of the contents of the drum), to a higher speed for drying.

Thus a preferred method of the invention generally comprises the steps: (a) providing a dryer as described above, (b) rotating the drum at a pre-determined loading speed, (c) varying the speed with which the objects to be dried are moved into the drum of the loading apparatus to load the objects to be dried from the back of the drum of the front of the drum, and (d) increasing the rotation speed of the drum to a pre-determined drying speed;

The method may further include the steps: (e) decelerating the drum to a predetermined unloading speed, (f) opening the containment door 12, and (g) using gravity to urge the objects out of the rotating drum.

The method may also further include the step of: (h)providing a conveyor means for collecting the objects emptied for the drum and transporting the objects to a next processing step.

In some methods of the invention, step (c) above further comprises the sub step of changing the rotational speed of the drum in a linear relationship to the change in the speed that objects to be dried are moved into the drum 10. In another preferred method, step (c) includes the substep of re-accelerating the loading apparatus, then again varying the speed with which the objects to be dried are moved into the drum to form a second layer from the back of the drum of the front of the drum.

An alternative method may include an alternative step (d) wherein the objects to be dried in step (c) are at least partially compressible, the alternative step comprising: (d) accelerating the drum 10 using centrifugal force to compress the previously loaded at least partially compressible objects to increase the empty volume of the drum; and (e) repeating step (c) in order to load additional objects to be dried.

When drying compressible objects, improved drying performance may be obtained by including the additional step (d) alternately increasing and decreasing the revolutions per minute (RPM) of the drum in order to repeatedly compress and flex the objects.

One advantage of the invention is its ability to more gently force the produce or vegetables to the outer wall of the cylinder for proper drying and to provide proper load balancing. Other advantages include a reduction in fabrication costs (1) from removing the central support structure used in prior art dryers, (2) from using the difference in diameters of the motor spindle and cylinder to provide the speed-reduction gearing and (30 from eliminating the ball-bearing support used in prior art for mounting the cylinder onto the frame in favor of trunion wheels or the like.

### LIST OF DRAWINGS

A better understanding of the present invention will be had upon reference to the accompanying drawings in which like numerals refer to like parts in the several views and in which:

FIG. 1 is a side view of a preferred embodiment of the centrifugal dryer according to the present invention

FIG. 2A is a perspective rear view of the embodiment of FIG. 1, with the containment door open.

FIG. 2B is a perspective rear view of the embodiment of FIG. 1, with the containment door closed.

FIG. 3 is a partial cut-away side view of the centrifugal dryer.

FIG. 4A is a side of the centrifugal dryer during loading

FIG. 4B is a side of the centrifugal dryer during unloading

### DETAILED DESCRIPTION

This invention includes both a mechanical apparatus for drying objects, and a method of efficiently loading, extracting surface water, and unloading the objects. The dryer of the invention maybe used for drying many kinds of solid-form objects, but is particularly suited for use in drying produce and vegetables. The dryer may be used for drying many kinds of objects, but is particularly suited for use in drying washed most kinds of produce and vegetables including but not limited to leaf vegetables.

In general, the dryer includes a variable speed loading apparatus for loading objects into a drum having perforated walls to allow liquid to escape. The drum is open at the front or loading end, and includes a preferably domed shaped retaining door controlling the exit of vegetables from the drum. The preferred dome shape of the door is thought to be unique and provides a number of benefits that will be discussed later.

Associated with the dryer of the invention is a method to vary the speed of the loading mechanism thereby allowing an even stacking and distribution of the objects within the drum. The method also includes steps involving varying the drum rotation speed from a slow rotation during loading to one or more higher drying speeds. Rotating the drum during loading in accordance with the method of the invention has been found to enhance self-balancing of the contents of the drum.

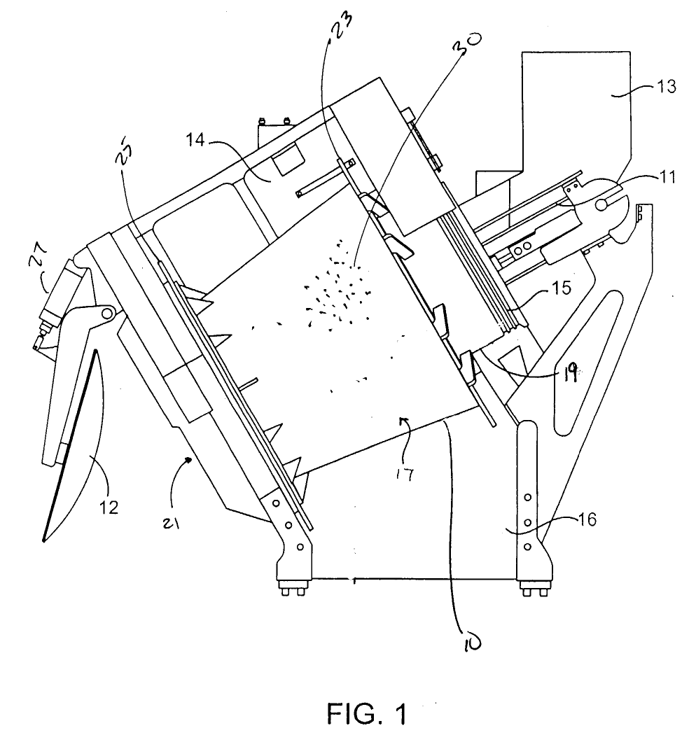

The major components of the apparatus are shown in FIG. 1. Objects to be dried are fed into hopper 13 and carried into drum 10 using accelerator belt 11. Motor 14 supplies the energy to rotate drum 10 using a drive belt. A housing surrounding the drum (not shown) captures the extracted liquid as it exists the spinning drum. After drying, product containment door 12 is opened and the objects leave drum 10. The entire structure is supported by frame 16. The dryer is preferably fully automated, and such automation may be easily accomplished by one skilled in the art. The configuration shown and discussed in the figures is provided by way of example, and other configurations are comprehended to be within the scope of the invention.

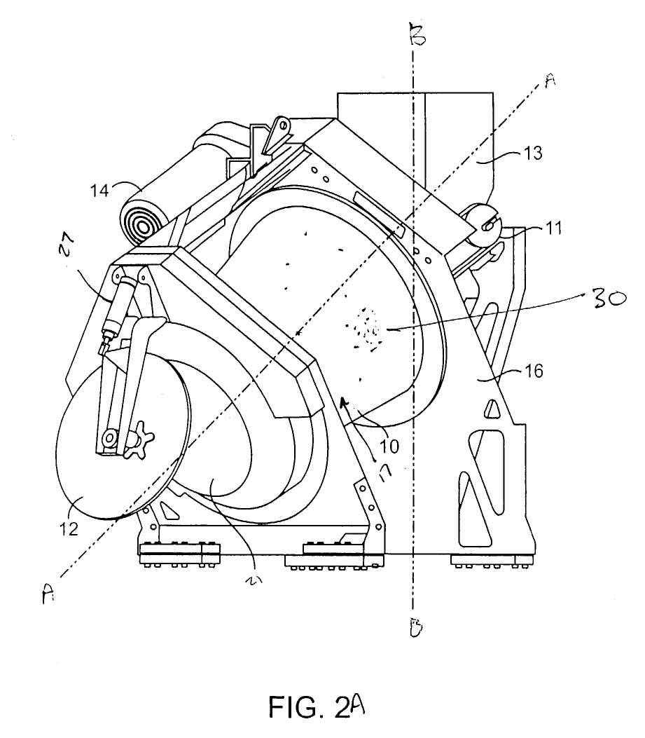

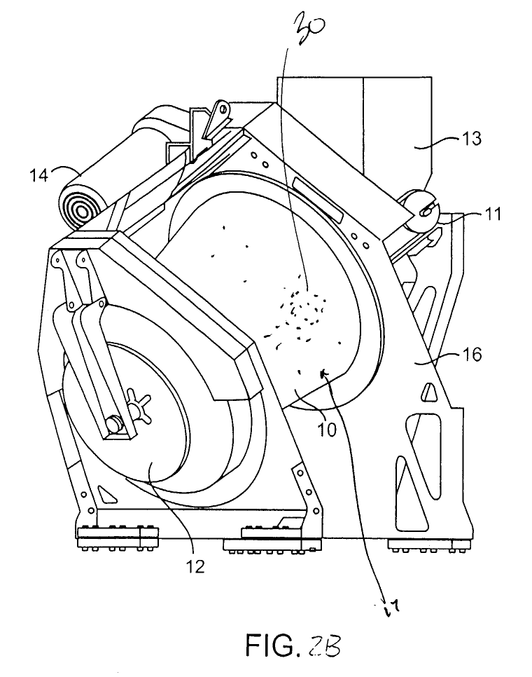

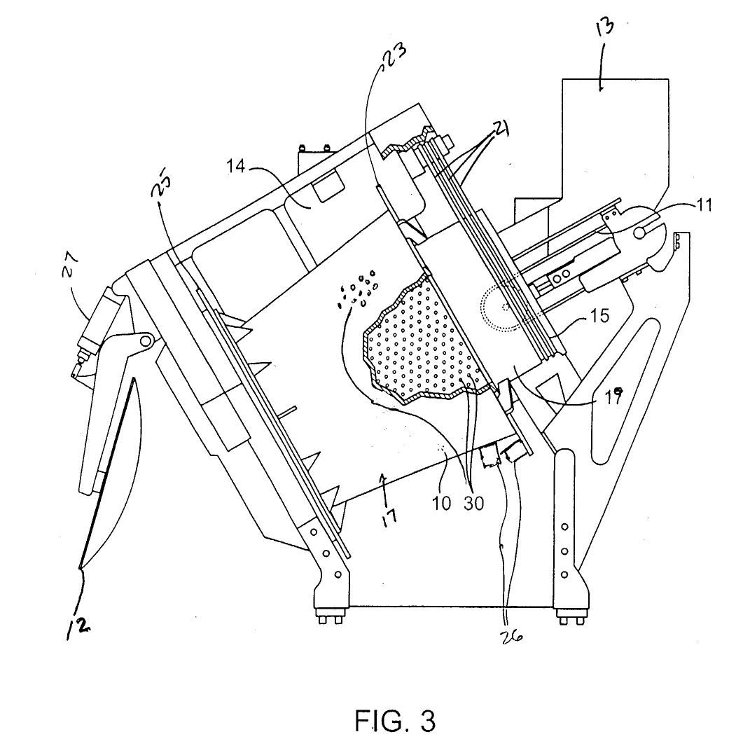

A rear perspective view of the apparatus is shown in FIG. 2A. Drum 17 is adapted to be rotated about its longitudinal axis A-A and canted with respect to its vertical axis B-B. Rotatable containment door 12 is domed shape and fits into the rear opening of drum 10 and is passively driven upon closing, as shown in FIG. 2B. That is, as the door 12 is configured to rotate freely, and when in contact with the rim of the drum opening 21, the door 12 will rotate with the drum 17. This door 12 self aligns to the end of the drum 17 because of its domed shape. An additional benefit of using the dome shape for the containment door 12 is that, unlike a flat door, when the drum 17 is spinning, objects in the drum 17 will be accelerated toward the drum surface some distance back from the joint between the rear opening of drum 17 and the edge of the rotatable containment door 12. This helps prevent damage to the objects being dried. Any means for controlling the opening and closing of the door 12 may be used. In the preferred embodiment the door 12 is controlled by a pneumatic piston 27 (best seen in FIG. 3) which pivots the door 12 away for the opening 21. In other embodiments, other door shapes may be used.

Referring to FIG. 3, the drum 17 includes two sections comprising a tapered section 10 defining a chamber for holding the objects to be dried, and a cylindrical section 19. The tapered section is preferably both perforated and tapered along its entire length. The partial cutaway allows a view of a portion of the interior of the drum 17 and the apertures 30 visible therein. The cylindrical section 19 includes several channels 15 formed on the outer surface of the drum 17, which channels 15 are configured to received V-shaped drive belts 21. Drive motor 14 provides power to rotate drum 17 via one or more drive belts 21 which are looped around the circumference of the cylindrical section 19 of the drum, and seat within the channels 15. In alternate embodiments, the dryer could be easily adapted to use a different drive belt configurations by one skilled in the art. However, several important benefits are provided by the configuration seen in the drawings. Specifically, the fabrication costs of the dryer of the invention may be reduced, and reliability may be increased, by the simple design shown in the figures, wherein the ratio of the diameter of the motor spindle and the diameter of drum 17 is used to provide the proper speed reduction for the efficient transfer of the mechanical power. No separate gearing is required.

Drum 10 is center-less, meaning that no structure is required inside the drum as is used in some prior art, and rests on trunion wheels 26 supported by the frame 16. This design provides a number of valuable benefits. Eliminating the center spindle, and the support structures that typically extend from such spindle to the outer wall of the drum used in prior art dryers, allows easier loading, and a greater volume of the drum 17 is thus made useable. Use of trunion wheels 26 reduces expense associated with the large bearings used in pre-existing designs. The trunion wheels 26 can be placed at a variety of locations to support the drum, and one skilled in the art can easily select appropriate trunion wheels and locations for such wheels depending on the configuration of the drum and dryer. Generally placement of at least three trunion wheels 26 near each end of the drum 17 approximately 120 degrees apart is preferred. Also at least two trunion wheels 26 are preferably placed against one or more flanges such as flange 23 on the drum 17.

The preferred drum configuration provides several surfaces for contact by supporting trunion wheels 26. Specifically, the drum 17 preferably includes two flanges 23 and 25 which extend preferably roughly perpendicularly from the longitudinal axis A-A of the drum. One or more trunion wheels 26 support the drum 17 at the flanges 23 and 25. Other trunion wheels may be in contact with other portions of the drum 17, such as the cylindrical portion of the drum 19.

Drum 17 has perforated holes 30 along its surface allowing the liquid extracted from the objects to exit. In the preferred embodiment, a housing, not shown, collects the liquid extracted from the objects in the dryer, and the liquid is subsequently drained from the system. The size of the perforated holes 30 can be varied by one skilled in the art to accommodate many variables such as the likely top rotational speed of the drum 17 during use, the kind of objects which will be typically dried in the drum 17, and the nature of the liquid which will typically be extracted.

The invention also includes a variable speed loading apparatus for loading objects into a drum 17. In the preferred embodiment seen in the drawings, the variable speed loading apparatus is an acceleration belt 11. The drum 17 preferably rotates during the loading process. In the preferred embodiment, the multi-speed acceleration belt is partially inserted into drum 17 roughly aligned with the longitudinal axis A-A of the drum 17. The acceleration belt 11 may be run at a selected speed sufficient to send the objects being loaded toward the product containment door 12. As objects are loaded, the speed of the acceleration belt 11 is gradually reduced, so that objects are gradually positioned closer to the acceleration belt 11. This method allows a gradual controlled filling of the tapered section 10 of the drum 17. Because drum 17 is rotating during the loading process, deposition of objects is fairly even which may result in an automatic self-balancing of drum 17. Furthermore, those skilled in the art will appreciate that when drying somewhat compressible objects, the amount of objects that can be loaded into tapered drum section 17 is larger while the drum 10 is spinning then when the drum 10 is not moving because of the compression effect of the centrifugal force.

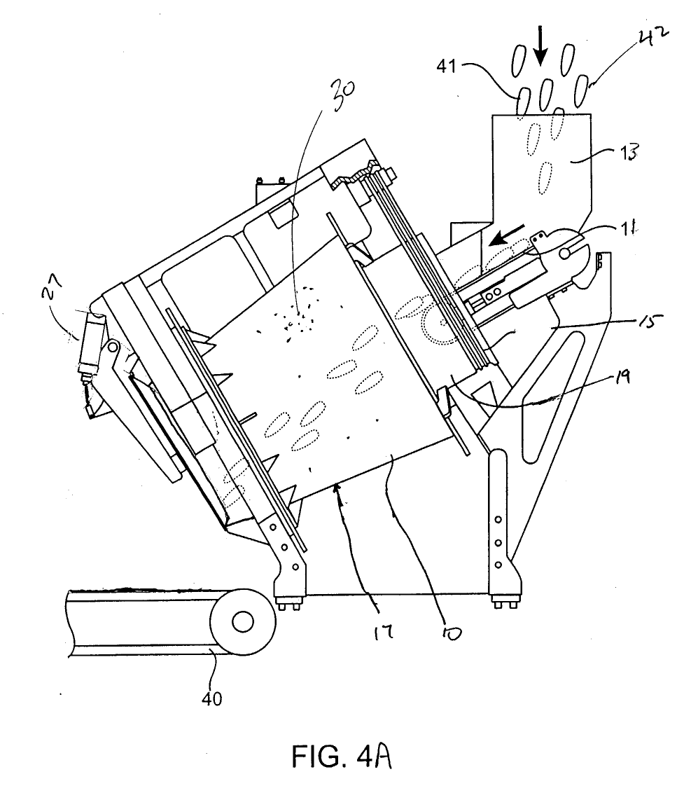

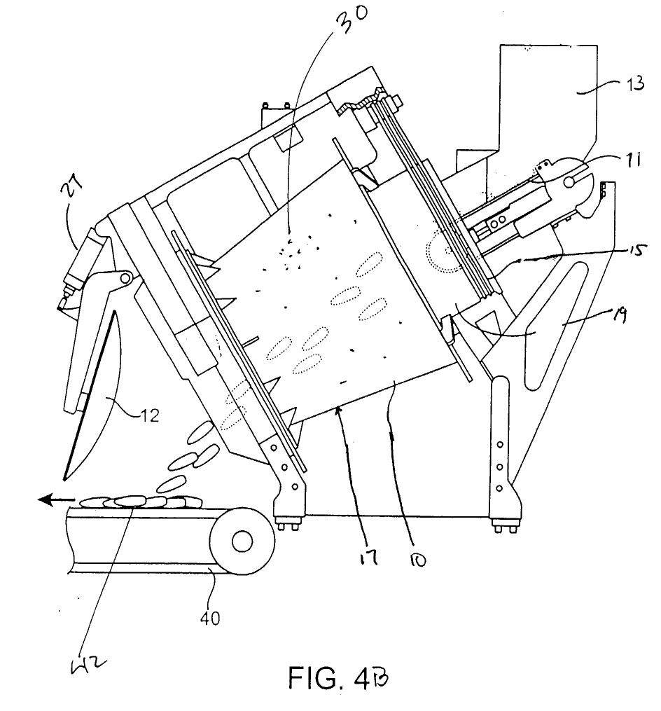

In use, the drum is rotated at a loading speed. The containment door 12 is closed, and the objects 42 to be loaded enter into hopper 13 and are dropped onto accelerator belt 11. Referring to FIG. 4A, the objects 42 are shown to be carrots, although as previously stated, many kinds of objects, including most kinds of produce and vegetables, may be dried in the dryer of the present invention. As the objects 42 reach the end of the accelerator belt 11, the objects 42 continue their forward motion and travel towards product containment door 12. Centrifugal force urges the objects 42 against the tapered walls of the rotary tapered drum section 17. Objects 42 continue to be launched from the accelerator belt to continuously fill tapered drum section 17. During the loading process the drum 10 may accelerate at a linear speed while the speed of the acceleration belt 11 decelerates to layer the vegetables evenly from front to back. In some variations on the method, the process may be repeated in order to layer additional objects in the center cavity of the drum 17. After filling the tapered drum section 10, the speed of the drum 17 is increased to a preset drying speed. Referring to FIG. 4B, the unloading sequence involves decelerating drum 17 to its unload speed. Product containment door 12 opens allowing the carrots to free flow out the end. In alternate embodiments blasts of compressed air may be used to assist the unloading process. The objects may be carried to the next processing step via conveyer belt 40.

Thus a preferred method of the invention comprises the steps:

a) providing a dryer comprising a rotating drum comprising a perforated tapered section, and a cylindrical drive section, a multi-speed accelerator belt allowing for objects to be placed sequentially at varying speed into the drum, support means in contact with at least one exterior surfaces of the drum for supporting the drum, and a domed shape product containment door, which door is in the closed position;

b) rotating said drum at a pre-determined loading speed;

c) varying the speed with which the objects to be dried are moved into the drum of the loading apparatus to load the objects to be dried from the back of the drum of the front of the drum;

d) increasing the rotation speed of the drum to a pre-determined drying speed;

The method may further include the steps:

e) decelerating the drum to a predetermined unloading speed;

f) opening the containment door 12;

g) using gravity to urge the objects out of the rotating drum.

The method may also further include the step of:

h) providing a conveyor means for collecting the objects emptied for the drum and transporting the objects to a next processing step.

In the preferred methods of the invention, step (c) above further comprises the sub step of changing the rotational speed of the drum in a linear relationship to the change in the speed that objects to be dried are moved into the drum 10. In another preferred method, step (c) includes the substep of re-accelerating the loading apparatus, then again varying the speed with which the objects to be dried are moved into the drum to form a second layer from the back of the drum of the front of the drum.

The method may further include the alternative steps following step (c) wherein the objects to be dried in step (c) are at least partially compressible of, (d) accelerating the drum 10 using centrifugal force to compress the previously loaded at least partially compressible objects to increase the empty volume of the drum; and (d) repeating step (c) in order to load additional objects to be dried. When drying partially compressible materials, step (d) of the method may include the sub-step of alternately increasing and decreasing the rpm of the drum in order to repeatedly compress and flex the objects, which has been found to improve drying performance.

Although exemplary embodiments of the invention have been described in detail above, those skilled in the art will readily appreciate that many additional modifications are possible without departing materially from the novel teachings and advantages of the invention. For example, different algorithms can be employed for changing the speed of the accelerator belt or the changing the speed of the rotating drum.

What is claimed is:

1. A dryer comprising:
a rotating drum comprising a perforated tapered section, and a cylindrical drive section,
a multi-speed accelerator belt allowing for objects to be placed sequentially at varying speed into said drum,
a support means in contact with at least one exterior surfaces of said drum for supporting said drum, and
a domed shape product containment door.

2. The dryer of claim 1, wherein said support means comprises a plurality of trunion wheels.

3. The dryer of claim 1, wherein said product containment door is passively driven to rotate by said drum.

4. The dryer of claim 1, wherein said product containment door is dome shaped.

5. The dryer of claim 1, wherein said drum rotates at a first speed while loading.

6. The dryer of claim 5, wherein said drum rotates at a second speed while drying.

7. The dryer of claim 1, wherein, during loading, said drum rotates at a speed that is in linear relationship with a speed of said loading belt.

8. A method for drying objects comprising the steps:
providing a dryer comprising a rotating drum comprising a perforated tapered section, and a cylindrical drive section, a multi-speed accelerator belt allowing for objects to be placed sequentially at varying speed into said drum, a support means in contact with at least one exterior surfaces of said drum for supporting said drum, and a means for unloading said drum;
rotating said drum at a pre-determined loading speed;
varying the speed with which the objects to be dried are moved into the drum of the loading apparatus to load the objects to be dried from the back of the drum of the front of the drum;
increasing the rotation speed of the drum to a pre-determined drying speed.

9. The method of claim 8, wherein said means for unloading said dryer includes a domed shape product containment door.

10. The method of claim 9, further comprising the steps:
decelerating the drum to a predetermined unloading speed;
opening said containment door;
using gravity to urge the objects out of said rotating drum.

11. The method of claim 8, further comprising the step:
providing a conveyor means for collecting the objects emptied from said drum and transporting the objects to a next processing step.

12. The method of claim 8, wherein said step of varying said speed with which said objects to be dried are moved into said drum further comprises the sub step of changing the rotational speed of the drum in a linear relationship to the change in the speed that objects to be dried are moved into the drum.

13. The method of claim 8, wherein said step of varying said speed with which said objects to be dried are moved into said drum further comprises the substep of re-accelerating the loading apparatus, then again varying the speed with which the objects to be dried are moved into the drum to form a second layer from the back of the drum of the front of the drum.

14. The method of claim 8, wherein said objects to be dried are at least partially compressible.

15. The method of claim 14, further comprising the step of accelerating said drum thereby using centrifugal force to compress the previously loaded at least partially compressible objects to increase the empty volume of said drum

16. The method of claim 15, further comprising repeating said step of varying said speed with which said objects to be dried are moved into said drum in order to load additional objects.

17. The method of claim 14, further comprising the step of alternately increasing and decreasing the rpm of said drum in order to repeatedly compress and flex the objects to improve drying performance.
